(19) United States
(12) Patent Application Publication
(10) Pub. No.: US 2010/0017731 A1
(43) Pub. Date: Jan. 21, 2010

(54) COMPUTER-READABLE RECORDING MEDIUM HAVING DRIVER PROGRAM STORED

(75) Inventor: Yoshiyuki Taira, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/417,398

(22) Filed: Apr. 2, 2009

(30) Foreign Application Priority Data
Jul. 18, 2008 (JP) 2008-187522

(51) Int. Cl. G06F 3/048

(52) U.S. Cl. 715/765; 715/274

(57) ABSTRACT

A computer-readable recording medium having a driver program stored may cause a computer to function as an icon display processor, an operation detector, a setting changing processor and/or an icon image switching processor. The operation detector may be configured to detect an operation performed on the icon displayed on the display device. The setting changing processor may be configured, when an operation has been detected by the operation detector, to change a setting value of a setting associated with the icon on which the operation has been performed to a different setting value. The icon display processor and/or icon image switching processor may be configured, according to the change in the setting value by the setting changing processor, to switch an icon image of the icon displayed on the display device from an icon image corresponding to a first setting value to a second setting value.

### INCORPORATION BY REFERENCE

This application is based upon and claims the benefit of priority from the corresponding Japanese Patent Application No. 2008-187522, filed Jul. 18, 2008, the entire contents of which is incorporated herein by reference.

### FIELD OF THE INVENTION

The present invention relates to a computer-readable recording medium having a driver program stored.

### BACKGROUND OF THE INVENTION

Icon menus generally include an information icon and a restricted-state indication icon. The restricted-state indication icon indicates whether performance of an operation on the information icon is restricted. In an icon menu, a user is generally able to specify whether performing an operation on an information icon is restricted. However, when viewing an information icon, the user may not immediately understand the content of the settings associated with the information icon.

Furthermore, in order to enter the content of the setting associated with an icon, a user clicks on the icon to display a screen that includes an entry field. A user then enters the desired content of the setting into the screen. Thus, when an icon menu is provided, in order to change the content of a setting, a user needs to perform various operations as described above.

### SUMMARY OF THE INVENTION

An embodiment of a computer-readable recording medium may include a driver program. When executed the driver program may allow a user to immediately understand the content of a setting associated with an icon. The driver program may allow a user to change a setting value of a setting by performing a simple operation.

In an embodiment, a computer-readable recording medium including a stored driver program may allow a computer to function as an icon display processor, an operation detector, a setting changing processor and/or an icon switching processor. The icon display processor may be configured to display an icon on a display device. The operation detector may be configured to detect an operation performed on the icon displayed on the display device. After an operation has been detected, the setting changing processor may change a setting content (i.e., setting value) associated with the icon on which the operation has been performed to different content. In accordance with the changes made by the setting changing processor, the icon image switching processor and/or icon display processor may be configured to switch an icon image of the icon currently displayed on the display device. The icon image switching processor switches the icon image displayed from an icon image corresponding to the content of the setting from a first setting value (i.e., the setting value before being changed) to an icon image corresponding to a second setting value (i.e., the changed setting value).

The above and other objects, features, and advantages of the present invention will be more apparent from the following detailed description of the embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a schematic block diagram showing an example of the structure of a terminal apparatus including a computer executing a driver program stored on a recording medium according to an embodiment of the present invention;

FIG. 2 is a flowchart which describes the use of the terminal apparatus including the computer by executing a driver program stored on a recording medium according to an embodiment of the present invention;

FIG. 3 is an illustration showing an example of a plurality of icons on a screen displayed on the terminal apparatus shown in FIG. 1;

FIG. 4 is an illustration showing an example of a plurality of icon images used for an icon corresponding to a paper orientation setting shown in FIG. 3 and the display sequence of the icon images;

FIG. 5 is an illustration showing an example of a plurality of icon images used for an icon corresponding to a copy unit printing setting shown in FIG. 3 and the display sequence of the icon images; and

FIG. 6 is an illustration showing an example of a plurality of icon images used for an icon corresponding to a multiple pages grouping per paper setting shown in FIG. 3 and the display sequence of the icon images.

### DESCRIPTION OF THE PREFERRED EMBODIMENTS

Reference will now be made in detail to various embodiments of the invention, one or more examples of which are illustrated in the accompanying drawings. Each example is provided by way of explanation of the invention, and by no way limits the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents.

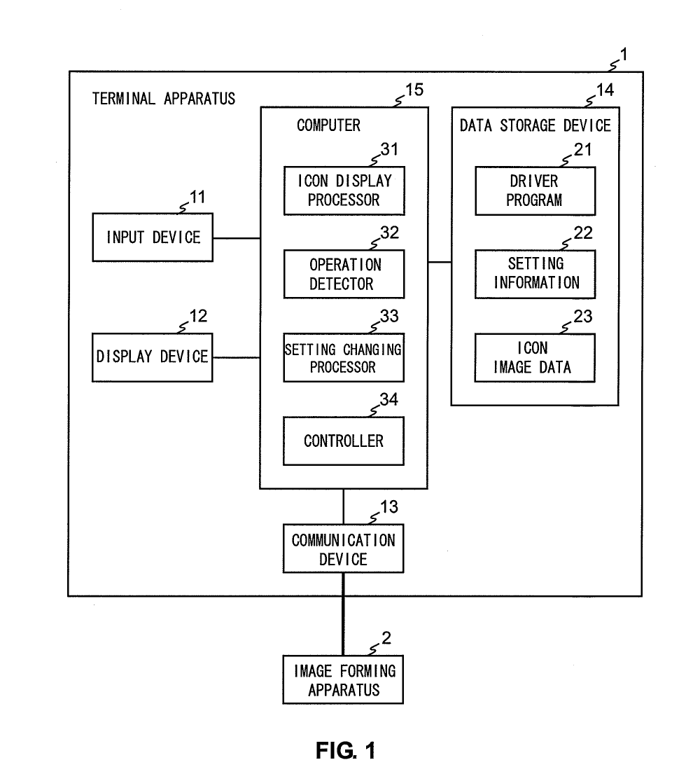

FIG. 1 depicts an embodiment of the structure of terminal apparatus 1. Terminal apparatus 1 includes computer 15 executing a driver program stored on a recording medium which allows the terminal apparatus to perform one or more desired functions.

In some embodiments, terminal apparatus 1 may be a personal computer, a hand held device, and/or any device which includes a computer-readable recording medium having a driver program stored.

An image forming apparatus 2 couples to terminal apparatus 1 through a communication channel including, but not limited to a cable, an interface cable, such as a peripheral apparatus interface cable, or a computer network (e.g., wireless and/or wired). Image forming apparatus 2 may serve as a peripheral apparatus. The functions of the image forming apparatus may include, but are not limited to a printing function, an image reading function, a facsimile transmission function, a facsimile reception function, and/or any combination of the functions.

One embodiment of terminal apparatus 1 may include computer 15, input device 11, display device 12, communication device 13, and data storage device 14.

Input device 11 may include any device configured to detect a user operation and output an indication of the user operation as an electric signal. Input device 11 includes but is not limited to a peripheral device, a keyboard, a pointing device, a mouse, a microphone, a camera, a touch screen, a light pen, a joystick, a touch panel, or any other device known or yet to be discovered in the art.

Display device 12 is configured to receive an electric signal containing image and/or video data to display an image corresponding to the electric signal on a screen. Display device 12 may include, but is not limited to a liquid crystal display, cathode ray tube display, cholesteric liquid crystal display, digital light processing display, electroluminescent display, field emission display, laser TV display, light-emitting diode display, liquid crystal on silicon display, organic light-emitting diode display, plasma display panel, surface-conduction electron-emitter display, vacuum fluorescent display, or any other display known or yet to be discovered in the art. For example, display device 12 may be a printer screen. In some embodiments, display device 12 may be a printer driver screen.

Communication device 13 may be any device that can be configured to communicate with a peripheral apparatus, such as image forming apparatus 2. In some embodiments, a communication device may be configured to communicate with the image forming apparatus through a specific communication channel. Communication device 13 may include, but is not limited to a peripheral apparatus interface, a network interface card (NIC), a network card, a network adapter, a network interface controller, LAN adapter, or any other device known or yet to be discovered in the art.

Data storage device 14 may be any device configured to store data and programs. A data storage device may include, but is not limited to a hard disk drive, optical storage device, magneto-optical disk, flash memory (e.g., USB sticks or keys), floppy disks, magnetic tape, standalone RAM disks, zip drives, any nonvolatile memory or any other device known or yet to be discovered in the art. In an embodiment, driver program 21, setting information 22 including the setting values of a plurality of settings, and icon image data 23 are stored in data storage device 14. Icon image data 23 may include image data of a plurality of icon images. An icon image may include text, photographic, and/or illustration data.

Driver program 21 may be stored on and supplied by a recording medium. A recording medium may include but is not limited to read-only memory (ROM), a hard disk, a universal serial bus (USB) memory, a flexible disk, a memory card, or a magneto-optical disk, that can be read by computer 15. When driver program 21 is read from the recording medium to computer 15, instructions are transmitted to each of the component parts constituting computer 15, and each of the component parts performs a corresponding process.

A computer may include, but is not limited to a central processing unit (hereinafter referred to as “CPU”), random-access memory (hereinafter referred to as “RAM”), read-only memory (hereinafter referred to as “ROM”), or any other device known or yet to be discovered in the art. Various processing units may be implemented when a driver program is loaded to the RAM and executed by the CPU. For example, for the configuration shown in FIG. 1, driver program 21 may be executed by computer 15. Thus, the icon display processor 31, operation detector 32, setting changing processor 33, and controller 34 may be implemented according to various embodiments of the present invention.

In some embodiments, icon display processor 31 may serve as an icon display processor and/or an icon image switching processor. Icon display processor 31 is a processing unit configured to display an icon on display device 12 and to switch an icon image of the icon. When the setting value of the setting is changed by setting changing processor 33, the icon image of the icon displayed on display device 12 is switched. The icon image is switched to an icon image corresponding to the setting value of the setting. In some embodiments, the setting value of the setting may have a predetermined sequence. Thus, when an operation is performed on an icon, the setting may be changed in a specific order of setting values. In addition, the icon images displayed may correspond to the setting values. Thus, in an embodiment the icon images may be displayed in a specific sequence corresponding to the sequence of the setting values.

Operation detector 32 is a processing unit that may detect operations performed on an icon on display device 12. Operation detector 32 may be configured to detect an operation performed on an icon displayed on display device 12. For example, operation detector 32 may detect when a user clicks on an icon on display device 12.

An operation as used herein may be performed to change a setting value of a setting in the herein described embodiments. In some embodiments, an operation may be a series of movements. In some embodiments, an operation may include, but is not limited to various movements, clicks, keystrokes, mouse movements, finger movements, sounds, light and any other operations known or used in the art. For example, a click operation may be a single click, a double click, or a series of clicks.

As shown in FIG. 1, setting changing processor 33 is a processing unit configured to change the setting value of the setting associated with an icon on which the click operation has been performed. The setting value of the setting is changed to a different setting value when an operation has been detected by operation detector 32.

Controller 34 is a processing unit configured to control image forming apparatus 2 based on a setting value of the setting.

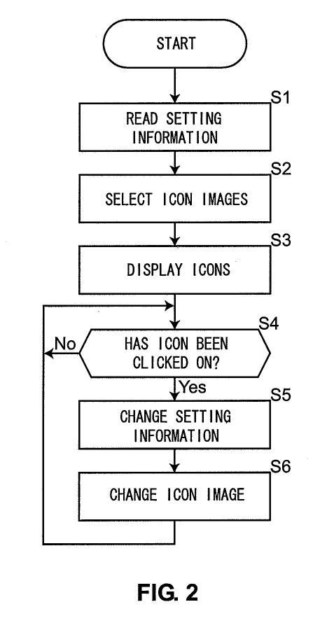

FIG. 2 depicts a flowchart detailing the operation of terminal apparatus 1 according to an embodiment. Terminal apparatus 1 includes computer 15 and at least one recording medium. In some embodiments, a driver program is stored on the recording medium. An embodiment may include multiple driver programs stored on the recording medium. Alternately, an embodiment may include more than one recording medium. The driver program may configure the computer to perform one or more functions. In some embodiments, multiple driver programs may be used to control the computer to perform at least one function.

Icon display processor 31 displays an initial screen of an icon menu and reads setting information 22 from data storage device 14. As shown in Step S1, setting information 22 indicates the current contents for a plurality of settings.

In Step S2, icon display processor 31 reads icon image data 23 of the icons from data storage device 14. The icon image data of icons corresponds to the current setting values of the individual settings. During Step S3, icon display processor 31 displays icons with icon images corresponding to the current setting values of the individual settings on display device 12. Accordingly, an icon menu is displayed.

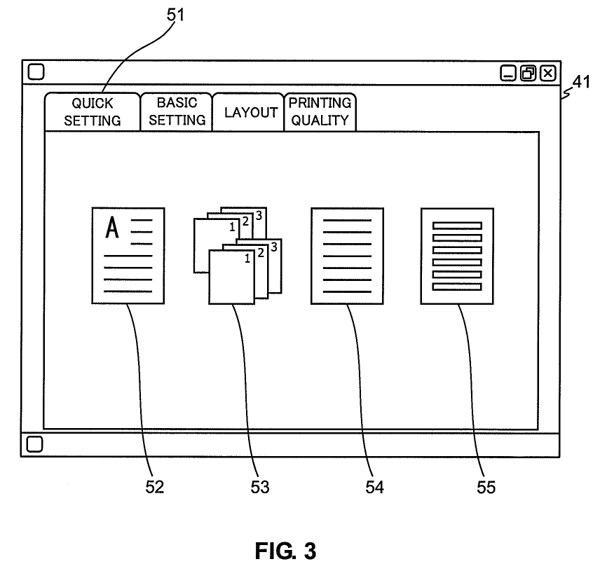

As described above, the icons corresponding to the setting values for the setting may be displayed as is shown in FIG. 3. Thus, a user is able to immediately view and understand the contents currently set for the individual settings.

As shown in FIG. 3 an embodiment may include a plurality of icons displayed on display device 12 of terminal apparatus 1 (as shown in FIG. 1). Settings displayed on an icon menu may include, but are not limited to printer settings, copy settings, fax settings, scanner settings, file format settings, scanning function settings, color settings (e.g., color balance, hue, auto exposure, sharpness, and/or color calibration), power-saving settings, noise level settings, orientation of paper settings, orientation of image settings (e.g., an auto-center, overlay, image rotate, and/or image reverse ), collate settings, printing on multiple side settings, multiple pages per sheet settings, input material settings, paper size, paper weight, resolution settings, finishing settings (e.g., binding settings, stapling settings, hole punch settings), security settings, magnification settings, zoom settings (e.g., copy ratios and/or x-y zoom settings), batch copy settings, booklet settings, book settings, combine image settings, insertion settings, erase settings, job build settings, job queue settings, margin shift settings, mirror image settings, memo mode, modify copy settings, proof copy settings, page numbering settings, transparency mode settings, job time information, shortcut key settings, document management settings (e.g., store documents, file merge, forms composition), repeat copy settings and any other settings known in the art. Each setting as described may include one or more setting values with each setting value corresponding to an icon image.

As shown in FIG. 3, an icon menu may be represented using tab screen 51 within window 41. An icon menu may include four icons 52, 53, 54, 55. For example, icon 52 relates to a paper orientation setting. Icon 53 relates to a copy unit printing setting. Icon 54 relates to a multiple pages grouping per paper setting. Icon 55 relates to a color mode setting.

The setting values of the paper orientation setting may include, but are not limited to “portrait” or “landscape”. Icon image data 23 of a “portrait” icon image and a “landscape” icon image are stored in data storage device 14. The icon images may be selected in accordance with the setting selected in the orientation setting for icon 52. In the icon menu shown in FIG. 3, the “portrait” icon image is used for icon 52.

The setting values for the copy unit printing setting may include, but are not limited to “sort” or “collate”. Icon image data 23 of a “sort” icon image and a “collate” icon image also may be stored in the data storage device 14. One of the icon images may be selected for icon 53 in accordance with a setting value selected in the copy unit printing setting. As shown in FIG. 3, icon 53 may display the “sort” icon image in the icon menu.

The setting values of the multiple pages grouping per paper setting may include, but are not limited to “1-up”, “2-up”, or “4-up”. Icon image data 23 of the “1-up” image icon, the “2-up” icon image, and/or the “4-up” icon data are stored in data storage device 14 (shown in FIG. 1). One of the icon images is selected for icon 54 in accordance with the setting value currently set in the page grouping setting. As shown in FIG. 3, icon 53 may display the “1-up” icon image in the icon menu.

The setting values for the color mode setting content may include, but are not limited to “color” or “monochrome”. Icon image data 23 of a “color” setting and/or a “monochrome” setting are stored in data storage device 14 (shown in FIG. 1). One of the icon images is selected for icon 55 in accordance with the setting value currently set in the color mode setting. The icon menu shown in FIG. 3 shows a “color” icon image is used for icon 55. In some embodiments, icon 55 for the “color” icon image is drawn in a plurality of colors. In some embodiments, the “color” icon image may be drawn in any number of colors (e.g., a single color, two colors, etc.). Thus, a user is able to immediately view and understand the fact that “color” is set as the color mode setting content. In addition, some embodiments may include the “color” icon image drawn in black and white as is shown in FIG. 3.

In some embodiments, the number of icons may vary. The number of icons present may be any suitable number. For example, some icon menus may include one, two, three, four, five or more icons. In some embodiments, icons which are used infrequently may be automatically changed to an icon of a different setting. An embodiment may include an icon for each setting of interest.

Referring back to FIG. 2, in Step S4 operation detector 32 determines whether the user has operated input device 11 to perform an operation. Operation detector 32 uses a signal transmitted from input device 11 to determine whether a click operation was performed on any one of icons 52, 53, 54, 55 (shown in FIG. 3). For example, operation detector 32 may be configured to detect clicks on any one of the icons present on the input device 11.

During Step 5 of FIG. 2, when operation detector 32 determines that a click operation has been performed, setting changing processor 33 changes the setting value of the setting associated with the icon on which the operation has been performed. For example, when icon 52 shown in FIG. 3 has been clicked on, the paper orientation setting value associated with icon 52 is changed from “portrait” to “landscape”. In some embodiments, the user is able to select or specify a different setting using only a click operation. Thus, a setting may be changed without performing an operation for selecting a setting value from a list of a plurality of setting values of a setting.

Furthermore, when operation detector 32 determines that a click operation has been performed, icon display processor 31 changes the icon image of the icon on which the click operation has been performed. In Step S6, the icon image of the icon is changed from the current icon image corresponding to the setting value of the setting to the icon image corresponding to the setting value of the changed setting. For example, clicking on icon 52 shown in FIG. 3 will change the content of the paper orientation setting associated with icon 52 from “portrait” to “landscape”. In this case, the icon image of icon 52 is changed from the “portrait” icon image to the “landscape”.

Thus, when an operation performed on an icon has been detected, the setting value of the setting associated with the icon is changed, and the icon image is also changed accordingly.

In further embodiments, the sequence of changes to the setting value of the settings that occur in response to detection of an operation can be set in advance. In some embodiments, every time an icon operation is detected, the setting value of the setting associated with the icon is changed according to a predetermined sequence. After reaching the last setting value in the predetermined sequence of some embodiments, the setting value of the setting may be returned to the first setting value in the predetermined sequence.

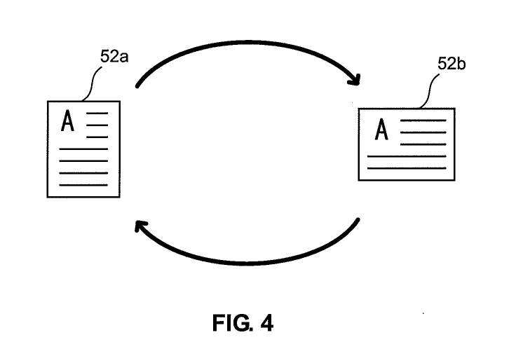

FIG. 4 depicts icon images that may be used for icon 52 corresponding to the paper orientation setting shown in FIG. 3. In addition, FIG. 4 shows the display sequence of the icon images. In some embodiments, a plurality of icon images may be used to show a paper orientation setting.

For example, when “portrait” and “landscape” are set as the content of the paper orientation setting in that specific sequence, the content of the setting of paper orientation is changed in the sequence of “portrait”, “landscape”, “portrait”, “landscape”, and so on. As shown in FIG. 4, the icon image of icon 52 may be switched in the sequence of icon image 52a representing “portrait”, icon image 52b representing “landscape”, icon image 52a representing “portrait”, icon image 52b representing “landscape”, and so on.

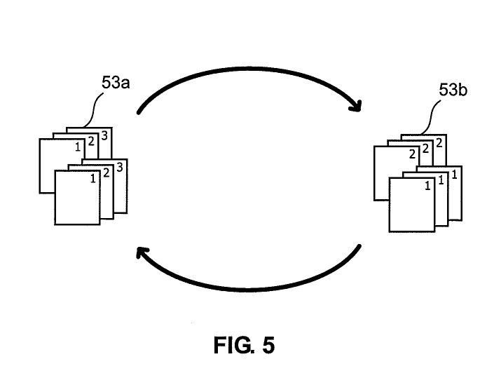

FIG. 5 is an illustration showing an example of a plurality of icon images used for icon 53 corresponding to the copy unit printing setting shown in FIG. 3 and shows the display sequence of the icon images.

When “sort” and “collate” are set as setting values of the copy unit printing setting in a specific sequence, the setting values of the copy unit printing setting can be changed in the sequence of “sort”, “collate”, “sort”, “collate”, and so on. Thus, as shown in FIG. 5, the icon image of icon 53 is switched in the sequence of icon image 53a representing “sort”, icon image 53b representing “collate”, icon image 53a representing “sort”, icon image 53b representing “collate”, and so on.

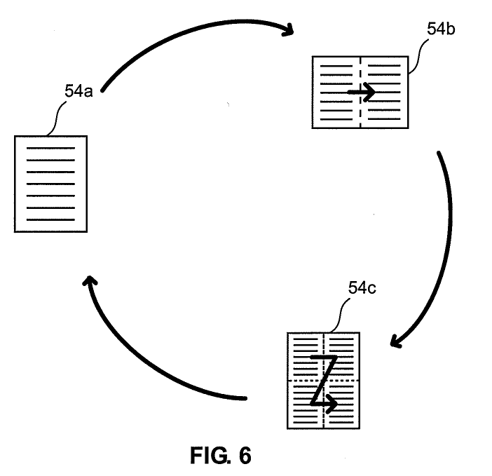

FIG. 6 is an illustration showing an example of a plurality of icon images used for icon 54 corresponding to the multiple pages grouping per paper setting shown in FIG. 3 and shows the display sequence of the icon images.

When “1-up”, “2-up”, and “4-up” are set as the setting values of the page grouping setting in that specific sequence, the setting values of the multiple pages grouping per paper setting is changed in the sequence of “1-up”, “2-up”, “4-up”, “1-up”, “2-up”, “4-up”, and so on. As shown in FIG. 6, the icon image of icon 54 may be switched in sequence from icon image 54a representing “1-up” to icon image 54b representing “2-up” to icon image 54c representing “4-up” to icon image 54a representing “1-up” to icon image 54b representing “2-up” to icon image 54c representing “4-up”, and so on.

When the contents of the settings are set as described above, and when a printing request is generated, controller 34 (shown in FIG. 1) generates printing data corresponding to the current setting values of the settings. Controller 34 transmits the generated printing data to image forming apparatus 2 via communication device 13. Thus, in image forming apparatus 2, a printing process is performed which reflects the setting values as described above for a plurality of settings regarding the printing function.

According to some embodiments of the terminal apparatus, when computer 15 executes driver program 21, then icon display processor 31, operation detector 32, setting changing processor 33, and controller 34 processing units are subsequently implemented. When operation detector 32 detects an operation, setting changing processor 33 changes the setting value of the setting associated with an icon on which the operation has been performed to a different setting value for the setting. Then, icon display processor 31 switches the icon from an initial icon image associated with the initial setting value to a new icon image associated with a new setting value. For example, when a user clicks on an icon displayed the first icon image (displayed before the clicking operation), is replaced with a second icon image displayed after the click operation.

Accordingly, the user is able to immediately view and understand the setting value of a setting associated with an icon and is able to change the setting value of the setting by performing a simple operation. For example, a user may click on an icon to change a setting from a first setting value to a second setting value.

In an embodiment, the setting value associated with an icon image is one of a plurality of setting values provided for the setting. Every time an operation performed on an icon is detected, the setting changing processor changes the setting value of the setting according to a predetermined sequence. In addition, the icon display processor may change the icon image displayed to correspond to the current setting value. Further, after reaching the end of a predetermined sequence, the setting value is returned to the first or original setting value in the predetermined sequence. In addition, the icon image is returned to the first icon image in the predetermined sequence.

By repeating operations, the switching of an icon image may be continued endlessly. Thus, since an icon image that has already been displayed can be displayed again only by repeating the same operations, that is, click operations, a desired content of a setting may be set by a simple operation.

As shown in FIG. 3, an icon display processor may display icons 52, 53, 54, 55 that are associated with the individual settings regarding the printing function on a screen of a display device 12, and operation detector 32 may detect a click operation performed on one of the icons 52, 53, 54, 55.

Thus, contents of a plurality of settings regarding a certain function can be collectively set on a single screen by simple operations. In addition, the contents of a plurality of setting that are frequently set for the printing function can be collectively set by simple operations. In some embodiments, a different icon image may be provided for each setting value of each setting. Thus, the user is able to immediately view and understand the current content of a setting in accordance with an icon image corresponding to the setting value.

In some embodiments, a plurality of setting values and a plurality of icon images or any may be provided for a setting. For example, four or more setting values and four or more icon images may be provided for a setting.

In an embodiment, controller 34 controls image forming apparatus 2 in accordance with the contents of the settings. Then, icon display processor 31 displays icons 52, 53, 54, 55 associated with the individual settings regarding a certain function of image forming apparatus 2.

Accordingly, the setting values of a plurality of settings that can be set by a driver of image forming apparatus 2 can be collectively set by simple operations.

In some embodiments, alternative designs may be used to perform the above-described components.

According to embodiments of the present invention, performing an operation on an icon may change the content of the setting for the clicked icon accordingly. However, in some embodiments, a particular content for a setting associated with a different icon cannot be selected. In these embodiments, that particular setting content may be removed from the sequence of setting values of the setting.

Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. A computer-readable recording medium having a driver program stored, the driver program causing a computer to function as:
an icon display processor configured to display an icon on a display device;
an operation detector configured to detect an operation performed on the icon displayed on the display device;
a setting changing processor configured to change a content of a setting from a first setting value associated with the one or more icons upon which the operation has been performed to a second setting value; and
wherein the icon display processor is configured to switch a first icon image of an icon to a second icon image on the display device according to the change in the setting from the first setting value to the second setting value executed by the setting changing processor.

2. The computer-readable recording medium of claim 1, wherein the setting further comprises a plurality of setting values, and wherein every time an operation performed on the icon is detected, the setting changing processor is configured to change the content of the setting in accordance with a predetermined sequence, and after reaching a last setting value in the predetermined sequence, the content of the setting is returned to the first setting value in the predetermined sequence.

3. The computer-readable recording medium of claim 1, wherein the icon display processor is configured to read the setting stored on data storage device, and wherein the icon display processor is configured to display the icon using the icon image corresponding to the content of the setting on the display device.

4. The computer-readable recording medium of claim 1, further comprising a second setting comprising a plurality of setting values.

5. The computer-readable recording medium of claim 1, wherein the icon display processor displays the plurality of icons associated with the plurality of settings for a printing function on the display device.

6. The computer-readable recording medium of claim 1, wherein the display device comprises a display device of a terminal apparatus comprising the computer.

7. The computer-readable recording medium of claim 1, wherein the driver program further causes the computer to function as:
a controller configured to control one or more peripheral apparatus in accordance with the content of the settings,
wherein the icon display processor displays a plurality of icons associated with a plurality of settings regarding a function of the peripheral apparatus.

8. The computer-readable recording medium of claim 7, wherein the function of the peripheral apparatus comprises a printing function, an image reading function, and/or a facsimile transmission/reception function.

9. The computer-readable recording medium of claim 1, wherein the setting comprises a paper orientation setting, wherein the first setting value comprises “portrait” and wherein the second setting value comprises “landscape”.

10. The computer-readable recording medium of claim 1, wherein the setting comprises a copy unit printing setting, wherein the first setting value comprises “sort” and wherein the second setting value comprises “collate”.

11. The computer-readable recording medium of claim 1, wherein the setting comprises a multiple pages grouping per paper setting, wherein the first setting value comprises “1-up”, wherein the second setting value comprises “2-up” and further comprising a third setting value comprising “4-up”.

12. The computer-readable recording medium of claim 1, wherein the setting comprises a color mode setting, wherein the first setting value comprises “color” and wherein the second setting value comprises “monochrome”.

13. The computer-readable recording medium of claim 1, wherein the operation detected by the operation detector comprises at least one of a click, a double click, at least one keystroke, at least one mouse movement, at least one finger movement, at least one sound, or at least one movement of light.

14. The computer-readable recording medium of claim 1, wherein the operation performed on the icon displayed on the display device comprises a click operation.

15. The computer-readable recording medium of claim 14, wherein the click operation detected by the operation detector includes at least one of a click, a double click, a finger gesture, or any mouse event.

16. A method of changing a setting on a display device comprising:
displaying an icon on a display device;
performing an operation on at least a portion of the icon on a surface of the display device;
detecting the operation performed on the icon; and
changing a content of a setting from a first setting value associated with the icon upon which the operation has been performed to a second setting value; and
switching the displayed icon from a first icon image corresponding to the first setting value to a second icon image corresponding to the second setting value on the display device.

17. The method of claim 16 further comprising:
providing an icon display processor configured to display the icon on the display device;
providing an operation detector configured to detect an operation performed on the icon displayed on the display device; and
providing a setting changing processor configured to change the setting from the first setting value to the second setting value.

18. The method of claim 16, wherein the operation detected comprises at least one of a click, a double click, at least one keystroke, at least one mouse movement, at least one finger movement, at least one sound, or at least one movement of light.

19. A computer-readable recording medium having a driver program stored, the driver program causing a computer to function as:
an icon display processor configured to display an icon on a display device;
an operation detector configured to detect an operation performed on the icon displayed on the display device;
a setting changing processor configured to change a setting associated with the icon upon which the operation has been performed to a second setting value; and
wherein the icon display processor is configured to change the icon from a first icon image to a second icon image corresponding to the second setting value.

20. A computer-readable recording medium having a driver program stored, the driver program causing a computer to function as:
an icon display processor configured to display an icon on a display device;
an operation detector configured to detect an operation performed on the icon displayed on the display device;
a setting changing processor configured to change a setting associated with the icon upon which the operation has been performed; and
an icon switching display processor configured to switch a first icon image of the icon to a second icon image of the icon on the display device according to the change in the setting value of the setting from a first setting value to a second setting value executed by the setting changing processor.
